(19) United States
(12) Patent Application Publication
(10) Pub. No.: US 2008/0055245 A1
(43) Pub. Date: Mar. 6, 2008

(54) Method, Apparatus, and Computer Program Product for Providing Non-Visual Access to On-Screen Menus for Remote Controlled Devices

(76) Inventors: Michael A. Migliacio, Rochester, MN (US); Christopher A. Peterson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/468,407

(22) Filed: Aug. 30, 2006

(51) Int. Cl. G09G 5/08

(52) U.S. Cl. 345/158

(57) ABSTRACT

A method, apparatus, and computer program product for providing non-visual access to on-screen menus for remote controlled electronic devices, such as DVD players, DVRs, VCRs, satellite receivers, televisions, etc. A repeater device is interposed between the remote control and the electronic device. The repeater device includes a receiver for receiving a first signal from the remote control and a transmitter for transmitting a second signal, based on the first signal, to a receiver of the electronic device. A repeater mechanism causes the repeater device to transmit the second signal and a feedback mechanism causes a non-visual response, such as an audio and/or Braille message, to be provided to the user. This response is based on a key pressed on the remote control in the context of a sequence of keys pressed earlier, and may inform the user of an action associated with the depressed key and options for additional keystrokes.

### BACKGROUND OF THE INVENTION

1. Field of Invention

The present invention relates in general to the digital data processing field. More particularly, the present invention relates to providing non-visual access to on-screen menus for electronic devices, such as DVD players, digital video recorders (DVRs), video cassette recorders (VCRs), satellite receivers, televisions, etc., which are controlled using a remote control.

2. Background Art

Many electronic devices, such as DVD players, digital video recorders (DVRs), video cassette recorders (VCRs), satellite receivers, televisions, etc., use on-screen menus to allow users to operate or configure the device. Typically, on-screen menus are inaccessible to people who are blind or visually impaired. Several solutions to this problem have been tried, but have met with only limited success. For example, the Zenith Speak EZ Talking VCR (available from Zenith Electronics Corporation, Lincolnshire, Ill.) features a voice that talks the user through the on-screen menu to operate and configure the VCR. Such talking devices represent a small fraction of the total number of electronic devices available on the market. Hence, a potential user of such a talking device must select from a market subset. That subset may not include the particular brand or model of the electronic device that the potential user would otherwise desire to purchase. For example, the potential user may desire a feature that is not available in the market subset.

The use of a stack of “reference cards” represents another solution to the on-screen menu inaccessibility problem experienced by people who are blind or visually impaired. These reference cards, typically written in Braille, explain to the user what is in each menu step and how to navigate between the menu steps. Unfortunately, reference cards are often complicated, difficult to use, and fail to provide any feedback to the user relative to whether the user is at the particular menu step he or she anticipates within the series of menu steps. For example, the user may be out-of-step with respect to the series of menu steps because he or she did not adequately aim the remote control at the electronic device during one or more of the menu steps, or because he or she miss-keyed or missed a menu step.

Yet another solution to the on-screen menu inaccessibility problem experienced by people who are blind or visually impaired is the use of a separate talking universal remote control. For example, the Cobalt Speechmaster Talking Remote Control (available from Cobalt Systems Ltd., Norfolk, England) can be programmed to work with a variety of electronic devices. Typically, talking universal remote controls usually do not provide every feature on the OEM remote control. Often, keys required to navigate one or more of the menu steps are among those omitted on the talking universal remote control. In another example, software may be installed in a portable electronic device, such as PDA or accessibility device (e.g., the PAC Mate series of devices available from Freedom Scientific, Blind/Low Vision Group, St. Petersburg, Fla.), to convert the portable electronic device into a talking universal remote control that may be used with variety of electronic devices. Unfortunately, such talking universal remote control devices fail to provide any feedback to the user relative to whether the electronic device is currently performing the particular menu step the user anticipates within the series of menu steps. For example, the talking universal remote control may be out-of-step with respect to the menu step that is currently being performed on the electronic device because the user did not adequately aim the talking universal remote control at the electronic device during one or more of the menu steps.

Consider, for example, what you might do to operate a VCR with on-screen menus if you were unable to actually see the menus themselves. If the menus were fairly straight forward, you might memorize the numeric options of the items you use most frequently. For example, to program a recording event, you might know that you need to press the menu key, followed by the number 2 to enter the recording menu, followed by the number 3 to add a weekly event on a specific day. Then, you might, from memory, enter the data (e.g., event start time, event end time, channel, etc.) into the event menu in the order that is expected. If your memory is good enough, you will have successfully scheduled a recording event on your VCR. Increasingly, however, user interfaces are becoming more complicated and difficult to memorize. In addition, human memory is an imperfect thing and, if you remember a step incorrectly, the result will not likely be the one you expect.

To compensate for imperfect memory, you might maintain a stack of reference cards as discussed above. However, if you do not accurately point the remote control at the electronic device, or you miss-key or miss a menu step, you have no way of knowing what you have done. This is the reality of many blind or visually impaired consumers of DVD players, digital video recorders (DVRs), video cassette recorders (VCRs), satellite receivers, televisions, or other electronic devices that are controlled using a remote control and on-screen menus. As the number of such electronic devices increases, and their user interfaces become more complex, the stack of reference cards becomes higher and higher. Hence, the potential for mistakes becomes greater and greater, and customer satisfaction drops lower and lower.

A need exists for an enhanced mechanism for providing non-visual access to on-screen menus for electronic devices that are controlled using a remote control. Without an enhanced mechanism for providing non-visual access, difficulties in accessing on-screen menus will continue for blind and visually impaired users of such devices.

### SUMMARY OF THE INVENTION

According to a preferred embodiment of the present invention, non-visual access to on-screen menus is provided for remote controlled electronic devices, such as DVD players, digital video recorders (DVRs), video cassette recorders (VCRs), satellite receivers, televisions, etc. A repeater device is interposed between the remote control and the electronic device. The repeater device includes a receiver for receiving a first signal from the remote control and a transmitter for transmitting a second signal, which is based on the first signal, to a receiver of the electronic device. In order to provide consistent accuracy in the case where the first and second signals are infrared (IR) signals, an IR transmitter of the repeater device is preferably located at a fixed position in a line-of-sight of an IR receiver of the electronic device. This arrangement overcomes the prior art's problem of inadequate aim of the remote control with respect to the electronic device. A repeater mechanism causes the repeater device to transmit the second signal and a feedback mechanism causes a non-visual response, such as an audio message and/or Braille message, to be provided to the user. This response may be based on a key pressed on the remote control in the context of a sequence of keys pressed earlier and may inform the user of an action associated with the depressed key and options for additional keystrokes.

The present invention provides persons who are blind or visually impaired with a significantly higher level of access to consumer electronics than has existed before. In accordance with the preferred embodiments of the present invention, no modification of existing consumer electronic devices is necessary to achieve this enhanced level of access. Hence, a potential user is not limited to selecting consumer electronic devices from a market subset, such as talking devices.

The foregoing and other features and advantages of the present invention will be apparent from the following more particular description of the preferred embodiments of the present invention, as illustrated in the accompanying drawings.

### BRIEF DESCRIPTION OF THE DRAWINGS

The preferred exemplary embodiments of the present invention will hereinafter be described in conjunction with the appended drawings, where like designations denote like elements.

FIG. 1 is a block diagram of a system for providing non-visual access to an on-screen menu for a remote controlled electronic device in accordance with the preferred embodiments.

FIG. 2 is a block diagram of another system for providing non-visual access to an on-screen menu for a remote controlled electronic device in accordance with the preferred embodiments.

FIG. 3 is a block diagram of a computer system for providing non-visual access to an on-screen menu for a remote controlled electronic device in accordance with the preferred embodiments of the present invention.

FIG. 4 is a flow diagram showing a method for providing non-visual access to an on-screen menu for a remote controlled electronic device in accordance with the preferred embodiments.

### DETAILED DESCRIPTION OF THE PREFERRED EMBODIMENTS

1.0 Overview

In accordance with the preferred embodiments of the present invention, non-visual access to on-screen menus is provided for remote controlled electronic devices, such as DVD players, digital video recorders (DVRs), video cassette recorders (VCRs), satellite receivers, televisions, etc. A repeater device is interposed between the remote control and the electronic device. The repeater device includes a receiver for receiving a first signal from the remote control and a transmitter for transmitting a second signal, which is based on the first signal, to a receiver of the electronic device. In order to provide consistent accuracy in the case where the first and second signals are infrared (IR) signals, an IR transmitter of the repeater device is preferably located at a fixed position in a line-of-sight of an IR receiver of the electronic device. This arrangement overcomes the prior art's problem of inadequate aim of the remote control with respect to the electronic device. A repeater mechanism causes the repeater device to transmit the second signal and a feedback mechanism causes a non-visual response, such as an audio message and/or Braille message, to be provided to the user. This response may be based on a key pressed on the remote control in the context of a sequence of keys pressed earlier and may inform the user of an action associated with the depressed key and options for additional keystrokes.

The present invention provides persons who are blind or visually impaired with a significantly higher level of access to consumer electronics than has existed before. In accordance with the preferred embodiments of the present invention, no modification of existing consumer electronic devices is necessary to achieve this enhanced level of access. Hence, a potential user is not limited to selecting consumer electronic devices from a market subset, such as talking devices.

2.0 Detailed Description

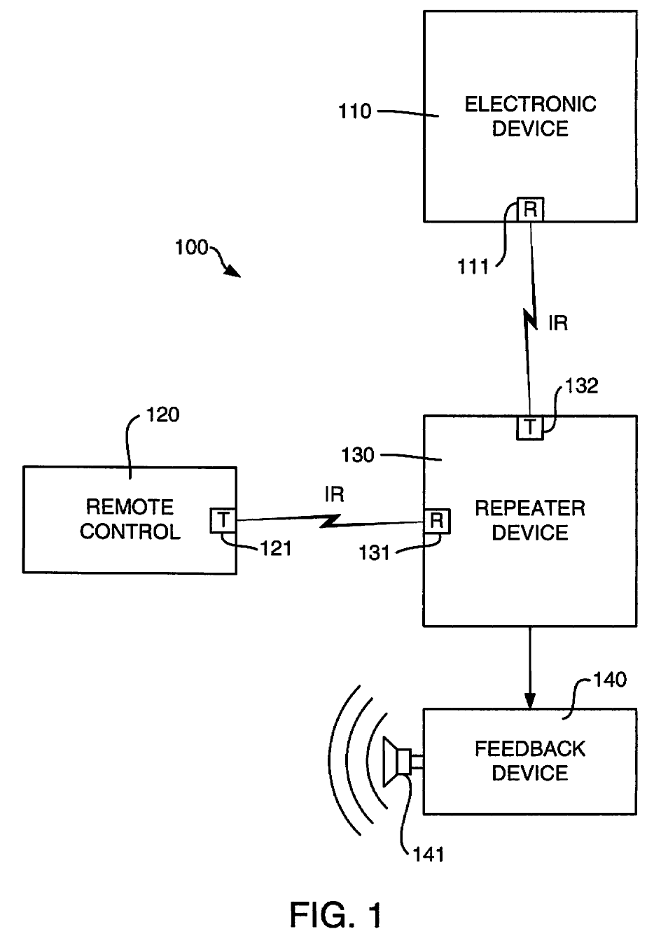

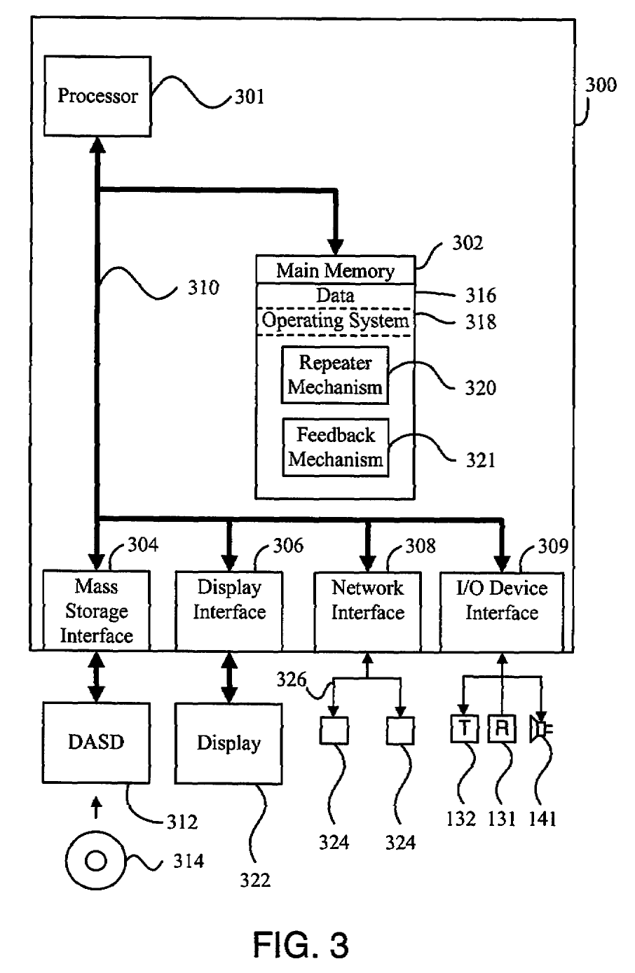

Referring to the Drawings, wherein like numerals denote like parts throughout the several views, FIG. 1 depicts a block diagram of a system 100 for providing non-visual access to an on-screen menu for a remote controlled electronic device in accordance with the preferred embodiments. The major components of the system 100 include an electronic device 110, a remote control 120 for the electronic device 110, a repeater device 130, and a feedback device 140. FIG. 1 is intended to depict the representative major components of system 100 at a high level, it being understood that individual components may have greater complexity than shown in FIG. 1, and that the number, type, and configuration of such components may vary. For example, the repeater device 130 and the feedback device 140 may be combined into a single dedicated unit or may be implemented in a general purpose computer system (such as discussed below with reference to FIG. 3).

The electronic device 110 may be any remote controlled electronic device, such as a DVD player, a digital video recorder, a satellite receiver, a television, etc. Although only a single remote controlled electronic device 110 is shown in FIG. 1, the present invention may be implemented to provide non-visual access to on-screen menus for any number of remote controlled electronic devices. The remote control 120 is typically an original equipment manufacturer (OEM) unit that is provided to facilitate the operation and configuration of the electronic device 110 through the use of on-screen menus. Alternatively, the remote control 120 may be a “universal” remote control or other portable electronic device programmed for use with the electronic device 110.

As is conventional, the electronic device 110 includes a receiver 111 and the remote control 120 includes a transmitter 121. In the prior art, the remote control's transmitter 121 transmits a signal, typically an infrared (IR) signal, to the electronic device's receiver 111 in response to the user pressing a key on the remote control 121. However, in accordance with the preferred embodiments of the present invention this signal from the remote control's transmitter 121 is intercepted, interpreted by the feedback device 140, and repeated by the repeater device 130. Although the signal transmitted by the remote control's transmitter 121 is shown in FIG. 1 as being an IR signal, those skilled in the art will appreciate that the use of an IR signal is exemplary and that the signal transmitted by the remote control's transmitter 121 may instead encompass one or more other frequency ranges, such as a radio frequency (RF) signal.

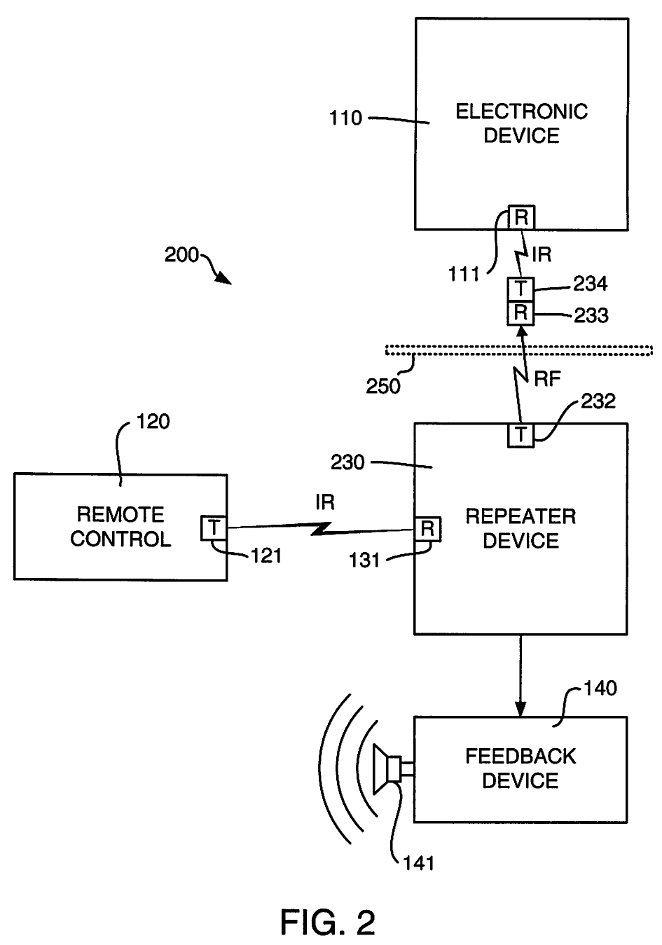

In the case where an IR signal is utilized, the IR signal may be intercepted by suitably positioning of the remote control 120 relative to the electronic device 110, i.e., the remote control's transmitter 121 is not aligned with the electronic device's receiver 111 so that the IR signal is not received at the electronic device's receiver 111 with sufficient strength to be recognized. Alternatively, as discussed below with reference to FIG. 2, the signal transmitted by the remote control's transmitter 121 may be intercepted by positioning the electronic device 110 behind a barrier that attenuates the signal, such as a panel of an equipment cabinet or a wall of residence or office.

Returning now to FIG. 1, the repeater device includes a receiver 131 and a transmitter 132. The repeater device's receiver 131 receives the IR signal transmitted from the remote control's transmitter 121. In the embodiment shown in FIG. 1, the repeater device's transmitter 132 repeats the IR signal received from the remote control's transmitter 121 by transmitting an identical IR signal from transmitter 132 to the electronic device's receiver 111. In this regard, the repeater device 110 is preferably maintained in a fixed location once the repeater device's transmitter 132 is aligned with the electronic device's receiver 111. This alleviates the inadequate aim problem that often occurs in the prior art when the remote control is moved out of proper alignment with respect to the electronic device.

In addition to forwarding the IR signal to the electronic device 110, the repeater device 130 passes the signal to the feedback device 140 where the signal is interpreted preferably in light of previous key presses, if any. The feedback device 140 includes an output device, such as a speaker 141 as shown in FIG. 1, a Braille display, and/or tone generator (e.g., for generating Morse code), that informs the user of the identity of depressed key and/or the action associated with the depressed key and options for additional keystrokes.

The feedback device 130 incorporates an interpretive algorithm for determining the identity of the depressed key based on the signal itself, and preferably an action associated with the depressed key and options for additional keystrokes based on any previous key presses. In other words, the interpretive algorithm includes a model of the electronic device's user interface that allows the feedback device 130 to predict what is shown on a user's on-screen menu based on a series of keys that the user has pressed. Hence, the interpretive algorithm is specific to the particular electronic device 110 in that the interpretive algorithm is provided with knowledge of the menu steps used by the electronic device 110 and how to navigate between the menu steps. The interpretive algorithm may utilize one or more lookup tables, for example, in making its determinations. The interpretive algorithm may be pre-programmed (e.g., the user may select from several pre-programmed interpretive algorithms for different electronic devices), manually programmed, transferred from a recording media, or downloaded over the Internet. Preferably, for more complicated and dynamic user interfaces, such as user interfaces that incorporate electronic program guides, the interpretive algorithm is dynamic so that it may be updated as the situation warrants.

The feedback device 130 also incorporates conventional speech synthesis algorithms, Braille synthesis algorithms and/or Morse code generating algorithms, each of which are well known in the art. After the interpretive algorithm determines the identity of the depressed key, and preferably an action associated with the depressed key and options for additional keystrokes, this information is conveyed to the user by invoking the conventional speech synthesis algorithm, Braille synthesis algorithm and/or Morse code generating algorithm.

For example, if the feedback device 130 utilizes speech synthesis and the user presses the “menu” button on the remote control 120 for controlling a digital video recorder or a VCR, the speaker 141 of the feedback device 130 may announce, “Menu; press 1 for timer check/set, press 2 for mode set, press 3 for tuner preset, or press 4 for clock set.” To accomplish this, the interpretive algorithm of the feedback device 130 determines that the “menu” button has been pressed, determines that menu selection is the action associated with the depressed key, and determines the various further possible keystrokes. The interpretive algorithm of the feedback device 130 passes this information on to the speech synthesis algorithm of the feedback device 130, which causes the speaker 141 of the feedback device 130 to announce the above recited message. Additionally, the speaker 141 may announce that the user may change “menu” keystroke before the keystroke is forwarded by the repeater device on to the electronic device.

It is important to note that if the user does not receive an announcement from the speaker 141 as expected after pressing one or more buttons on the remote control, then he or she will know that the remote control's transmitter is not adequately aimed at the repeater device's receiver.

Next, if the user presses the “1” button on the remote control 120, the speaker 141 of the feedback device 130 may announce, “Timer check/set; press four numeral keys to designate the month and date of event to be recorded, press the down arrow once for Sunday through Saturday, press the down arrow twice for Monday through Saturday, press the down arrow three times for Monday through Friday, press the down arrow four times for Weekly.” In this case, the interpretive algorithm of the feedback device 130 determines that the “1” key has been pressed, determines that “timer check/set” is the action associated with the depressed “1” key based on the “menu” button having been previously depressed, and determines the various further possible keystrokes. The interpretive algorithm of the feedback device 130 passes this information on to the speech synthesis algorithm of the feedback device 130, which announces the above recited message. Additionally, the speaker 141 may announce that the user may change the “1” keystroke before the keystroke is forwarded by the repeater device on to the electronic device.

If the user then presses the “down arrow” button on the remote control 120 three times, the speaker 141 of the feedback device 130 may announce, “Monday through Friday; press four numeral keys to designate a start time of the event to be recorded on the basis of a twenty-four hour clock.” In this case, the interpretive algorithm of the feedback device 130 determines that the “down arrow” key has been pressed three times, determines that “Monday through Friday” is the action associated with the depressing the “down arrow” key three times based on the sequence of previously pressed keys (i.e., “menu” button followed by the “1” button), and determines the various further possible keystrokes. The interpretive algorithm of the feedback device 130 passes this information on to the speech synthesis algorithm of the feedback device 130, which announces the above recited message. In addition, rather than waiting for the user to complete the series of keystrokes, the speaker 141 of the feedback device may announce the identity of the depressed key after each keystroke to provide the user with more awareness of his or her progress. Additionally, the speaker 141 may announce that the user may change this series of keystrokes before the keystrokes are forwarded by the repeater device on to the electronic device.

If the user then presses the “1”, “4”, “3”, and “0” buttons on the remote control 120, the speaker 141 of the feedback device 130 may announce, “Two Thirty P.M. Start Time; press four numeral keys to designate an end time of the event to be recorded on the basis of a twenty-four hour clock.” In this case, the interpretive algorithm of the feedback device 130 determines that the “1”, “4”, “3”, and “0” keys have been pressed, determines that “Two Thirty P.M. Start Time” is the action associated with the depressing the “1”, “4”, “3”, and “0” keys based on the sequence of previously pressed keys (i.e., “menu” button, then “1” button, and then “down arrow” three times), and determines the various further possible keystrokes. The interpretive algorithm of the feedback device 130 passes this information on to the speech synthesis algorithm of the feedback device 130, which announces the above recited message. Here too, rather than waiting for the user to complete the series of keystrokes, the speaker 141 of the feedback device may also announce the identity of the depressed key after each keystroke to provide the user with more awareness of his or her progress. Additionally, the speaker 141 may announce that the user may change this series of keystrokes before the keystroke are forwarded by the repeater device on to the electronic device.

If the user then presses the “1”, “5”, “3”, and “0” buttons on the remote control 120, the speaker 141 of the feedback device 130 may announce, “Three Thirty P.M. End Time; press three numeral keys to designate a channel of the event to be recorded.” In this case, the interpretive algorithm of the feedback device 130 determines that the “1”, “5”, “3”, and “0” keys have been pressed, determines that “Fifteen Thirty End Time” is the action associated with the depressing the “1”, “5”, “3”, and “0” keys based on the sequence of previously pressed keys (i.e., “menu” button, then “1” button, then “down arrow” three times, and then “1”, “4”, “3” and “0” buttons), and determines the various further possible keystrokes. The interpretive algorithm of the feedback device 130 passes this information on to the speech synthesis algorithm of the feedback device 130, which announces the above recited message. Again, rather than waiting for the user to complete the series of keystrokes, the speaker 141 of the feedback device may also announce the identity of the depressed key after each keystroke to provide the user with more awareness of his or her progress. Additionally, the speaker 141 may announce that the user may change this series of keystrokes before the keystrokes are forwarded by the repeater device on to the electronic device.

If the user then presses the “0”, “0”, and “2” buttons on the remote control 120, the speaker 141 of the feedback device 130 may announce, “Channel Two; press the “Enter” keys to confirm.” In this case, the interpretive algorithm of the feedback device 130 determines that the “0”, “0”, and “2” keys have been pressed, determines that “Channel Two” is the action associated with the depressing the “0”, “0”, and “2” keys based on the sequence of previously pressed keys (i.e., “menu” button, then “1” button, then “down arrow” three times, then “1”, “4”, “3” and “0” buttons, and then “1”, “5”, “3” and “0” buttons), and determines the various further possible keystrokes. The interpretive algorithm of the feedback device 130 passes this information on to the speech synthesis algorithm of the feedback device 130, which announces the above recited message. Here too, rather than waiting for the user to complete the series of keystrokes, the speaker 141 of the feedback device may also announce the identity of the depressed key after each keystroke to provide the user with more awareness of his or her progress. Additionally, the speaker 141 may announce that the user may change this series of keystrokes before the keystrokes are forwarded by the repeater device on to the electronic device.

If the user then presses the “Enter” button on the remote control 120, the speaker 141 of the feedback device 130 may announce, “Confirming Timer Set; the event on channel two will be recorded from two thirty p.m. to three thirty p.m. each day Monday through Friday.” In this case, the interpretive algorithm of the feedback device 130 determines that the “Enter” key has been pressed, determines that “Confirming Timer Set” is the action associated with the depressing the “Enter” key based on the sequence of previously pressed keys (i.e., “menu” button, then “1” button, then “down arrow” three times, then “1”, “4”, “3” and “0” buttons, and then “1”, “5”, “3” and “0” buttons, and then “0”, “0” and “2” buttons), and determines the various further possible keystrokes. The interpretive algorithm of the feedback device 130 passes this information on to the speech synthesis algorithm of the feedback device 130, which announces the above recited message Additionally, the speaker 141 may announce that the user may change the “Enter” keystroke before the keystroke is forwarded by the repeater device on to the electronic device.

The above example is set forth for illustrative purposes and many variations are possible within the scope of the present invention. One skilled in the art will appreciate that the present invention may be applied for providing non-visual access to any remote controlled electronic device that utilizes on-screen menus.

FIG. 2 depicts a block diagram of another system 200 for providing non-visual access to an on-screen menu for a remote controlled electronic device in accordance with the preferred embodiments. The system 200 shown in FIG. 2 is similar to the system 100 shown in FIG. 1, except that an RF signal is used so that the electronic device 110 may be controlled from behind an obstacle 250, such as a panel of an equipment cabinet or a wall of a residence or office. As shown in FIG. 2, the system 200 includes a repeater device 230 having an IR receiver 131, as well as an RF transmitter 232, an RF receiver 233, and an IR transmitter 234. The IR signal received by the IR receiver 131 from the remote control's IR transmitter 121 is transformed into an RF signal that is transmitted by RF transmitter 232 to RF receiver 233 on the other side of obstacle 250. The RF signal is transformed by the repeater device 230 back into an IR signal that is transmitted by IR transmitter 234, which is in a line-of-sight of the electronic device's IR receiver 111.

A computer system implementation of a preferred embodiment of the present invention will now be described with reference to FIG. 3 in the context of a particular computer system 300, i.e., an IBM eServer iSeries computer system. However, those skilled in the art will appreciate that the method, system and program product of the present invention apply equally to any computer system, regardless of whether the computer system is a complicated multi-user computing apparatus, a single user workstation, a PC, or an embedded control system. As shown in FIG. 3, computer system 300 comprises a processor 301, a main memory 302, a mass storage interface 304, a display interface 306, a network interface 308, and an I/O device interface 309. These system components are interconnected through the use of a system bus 310.

FIG. 3 is intended to depict the representative major components of computer system 300 at a high level, it being understood that individual components may have greater complexity than represented in FIG. 3, and that the number, type and configuration of such components may vary. For example, computer system 300 may contain a different number of processors than shown.

Mass storage interface 304 is used to connect mass storage devices (such as a direct access storage device 312) to computer system 300. One specific type of direct access storage device 312 is a readable and writable CD ROM drive, which may store data to and read data from a CD ROM 314.

Main memory 302 in accordance with the preferred embodiments contains data 316, an operating system 318, a repeater mechanism 320, and a feedback mechanism 321. While the repeater mechanism 320 and the feedback mechanism 321 are shown separate and discrete from operating system 318 in FIG. 3, the preferred embodiments expressly extend to repeater mechanism 320 and/or the feedback mechanism 321 being implemented within the operating system 318. In addition, repeater mechanism 320 and the feedback mechanism 321 could be implemented alone or together in application software, utilities, or other types of software within the scope of the preferred embodiments.

Computer system 300 utilizes well known virtual addressing mechanisms that allow the programs of computer system 300 to behave as if they have access to a large, single storage entity instead of access to multiple, smaller storage entities such as main memory 302 and DASD device 312. Therefore, while data 316, operating system 318, repeater mechanism 320, and feedback mechanism 321 are shown to reside in main memory 302, those skilled in the art will recognize that these items are not necessarily all completely contained in main memory 302 at the same time. It should also be noted that the term “memory” is used herein to generically refer to the entire virtual memory of the computer system 300.

Data 316 represents any data that serves as input to or output from any program in computer system 300. Operating system 318 is a multitasking operating system known in the industry as OS/400 or IBM i5/OS; however, those skilled in the art will appreciate that the spirit and scope of the present invention is not limited to any one operating system.

The repeater mechanism 320 provides the functionality of the repeater device 130 shown in FIG. 1. The feedback mechanism 321 provides the functionality of the feedback device 140 shown in FIG. 1. Accordingly, the feedback mechanism 321 includes the interpretive algorithm that was discussed earlier, as well as a conventional speech synthesis algorithm, Braille synthesis algorithm, and/or Morse code algorithm. As mentioned earlier, the interpretive algorithm may be pre-programmed (e.g., the user may select from several pre-programmed interpretive algorithms for different electronic devices), manually programmed, transferred from a recording media (e.g., CD ROM 314), or downloaded over the Internet (e.g., over network 326). Preferably, for more complicated and dynamic user interfaces, such as user interfaces that incorporate electronic program guides, the interpretive algorithm is dynamic so that it may be updated as the situation warrants.

Processor 301 may be constructed from one or more microprocessors and/or integrated circuits. Processor 301 executes program instructions stored in main memory 302. Main memory 302 stores programs and data that may be accessed by processor 301. When computer system 300 starts up, processor 301 initially executes the program instructions that make up operating system 318. Operating system 318 is a sophisticated program that manages the resources of computer system 300. Some of these resources are processor 301, main memory 302, mass storage interface 304, display interface 306, network interface 308, I/O device interface 309 and system bus 310.

Although computer system 300 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 301. However, those skilled in the art will appreciate that the present invention applies equally to computer systems that simply use I/O adapters to perform similar functions.

Display interface 306 is used to directly connect one or more displays 322 to computer system 300. These displays 322, which may be non-intelligent (i.e., dumb) terminals or fully programmable workstations, are used to allow system administrators and users (also referred to herein as “operators”) to communicate with computer system 300. Note, however, that while display interface 306 is provided to support communication with one or more displays 322, computer system 300 does not necessarily require a display 322, because all needed interaction with users and processes may occur via network interface 308.

Network interface 308 is used to connect other computer systems and/or workstations to computer system 300 across a network 326. The present invention applies equally no matter how computer system 300 may be connected to other computer systems and/or workstations, regardless of whether the network connection 326 is made using present-day analog and/or digital techniques or via some networking mechanism of the future. In addition, many different network protocols can be used to implement a network. These protocols are specialized computer programs that allow computers to communicate across network 326. TCP/IP (Transmission Control Protocol/Internet Protocol) is an example of a suitable network protocol.

The I/O device interface 309 provides an interface to any of various input/output devices. Three such devices, the repeater device's receiver 131, the repeater device's transmitter 132, and the feedback device's speaker 141, are shown in the exemplary embodiment of FIG. 3, but in other embodiments many other such devices may exist, which may be of differing types.

At this point, it is important to note that while this embodiment of the present invention has been and will be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROMs (e.g., CD ROM 314 of FIG. 3), and transmission type media such as digital and analog communications links (e.g., network 326 in FIG. 3).

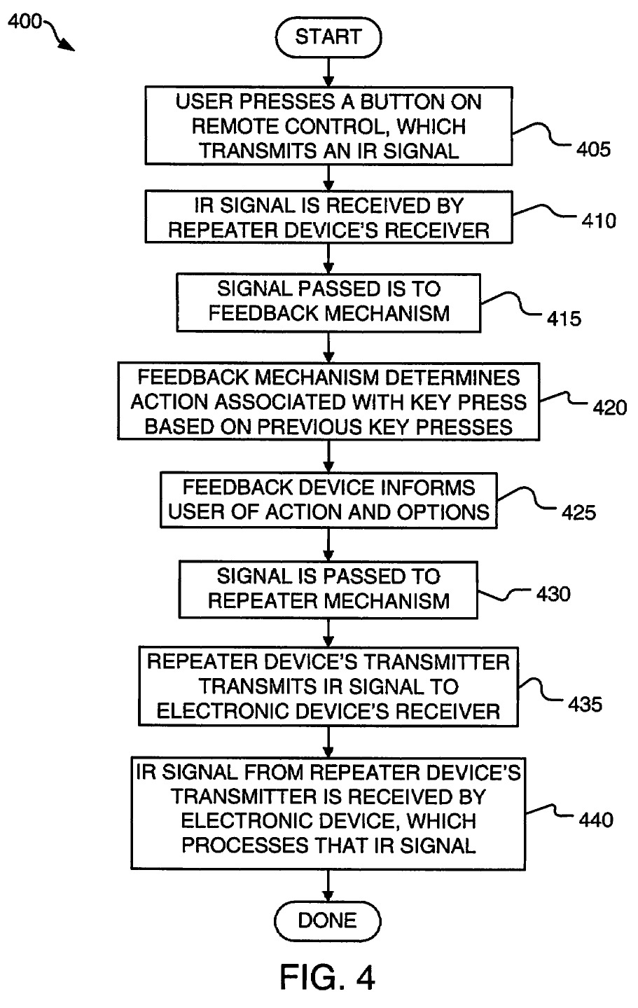

FIG. 4 depicts a flow diagram of a method 400 for providing non-visual access to an on-screen menu for a remote controlled electronic device in accordance with the preferred embodiments. In the method 400, the steps discussed below (steps 405-440) are performed. These steps are set forth in their preferred order. It must be understood, however, that the various steps may occur at different times relative to one another than shown, or may occur simultaneously. Moreover those skilled in the art will appreciate that one or more of the steps may be omitted. The method 400 begins as the user presses a button on the remote control, which transmits an IR signal from its transmitter (step 405). Then, the method 400 continues as the IR signal from the remote control's transmitter is received by the repeater device's receiver (step 410). Next, the signal that is output from the repeater device's receiver is passed to the feedback mechanism (step 415). The feedback mechanism then determines the identity of the depressed key, and based on any previous key presses, also determines an action associated with the depressed key and options for additional keystrokes (step 420). In this regard, the feedback mechanism invokes the interpretive algorithm as described earlier. Based on the information determined by the feedback mechanism, the feedback device then informs the user of the action and options (step 425). In this regard, the feedback mechanism may invoke a conventional speech synthesis algorithm, Braille synthesis algorithm, and/or Morse code algorithm.

Also, the signal that is output from the repeater device's receiver is passed to the repeater mechanism (step 430). Next, the repeater device's transmitter transmits an IR signal to the electronic device's receiver (step 435). The IR signal transmitted from the repeater device and received by the electronic device (step 440) is a copy of the original IR signal transmitted from the remote control and received by the repeater device. Accordingly, the electronic device will process the IR signal received from the repeater device just as it would have processed the original IR signal transmitted from the remote control.

The signal that is passed to the repeater mechanism in step 430 is the same signal that is passed to the feedback mechanism in step 415. Accordingly, steps 415-425 and steps 430-440 may be performed simultaneously rather than in the order shown in FIG. 4. However, it is generally desirable to perform the steps in the order shown in FIG. 4 to make certain that the user's keystrokes on the remote control are proceeding as intended before the repeater device forwards the keystrokes to the electronic device. In this regard, the method 400 may enable the user to change one or more keystrokes before forwarding the keystrokes on to the electronic device.

One skilled in the art will appreciate that many variations are possible within the scope of the present invention. For example, one skilled in the art will appreciate that although only a single remote controlled electronic device is shown in FIGS. 1 and 2, the present invention may be implemented to provide non-visual access to on-screen menus for any number of remote controlled electronic devices (e.g., various electronic devices housed together in an equipment cabinet). Thus, while the present invention has been particularly shown and described with reference to preferred embodiments thereof, it will be understood by those skilled in the art that this and other changes in form and details may be made therein without departing from the spirit and scope of the present invention.

What is claimed is:

1. An apparatus for providing non-visual access to an on-screen menu for an electronic device having a remote control, comprising:
at least one processor;
a memory coupled to the at least one processor;
a repeater device comprising
a receiver for receiving a first signal from a transmitter of the remote control, wherein the first signal is not received by a receiver of the electronic device but is operable for interaction with the on-screen menu for the electronic device in a case where the first signal is received by the receiver of the electronic device;
a transmitter for transmitting a second signal to the receiver of the electronic device;
a repeater mechanism residing in the memory and executed by the at least one processor, the repeater mechanism causing the transmitter of the repeater device to transmit the second signal to the receiver of the electronic device, said second signal being based on the first signal received by the receiver of the repeater device from the transmitter of the remote control;
a feedback mechanism residing in the memory and executed by the at least one processor, the feedback mechanism causing a non-visual response to be provided to a user of the electronic device, said non-visual response being based on the first signal received by the receiver of the repeater device from the transmitter of the remote control.

2. The apparatus as recited in claim 1, wherein the first signal and the second signal are infrared (IR) signals.

3. The apparatus as recited in claim 2, wherein an IR transmitter of the repeater device is located at a fixed position in a line of sight relative to an IR receiver of the electronic device.

4. The apparatus as recited in claim 1, wherein the electronic device includes at least one of a DVD player, a digital video recorder (DVR), a video cassette recorder (VCR), a satellite receiver, and a television.

5. The apparatus as recited in claim 1, wherein the non-visual response caused by the feedback mechanism includes providing at least one of an audio message and a Braille message to the user of the electronic device.

6. The apparatus as recited in claim 1, wherein the non-visual response is based on a key pressed on the remote control by the user.

7. The apparatus as recited in claim 6, wherein the non-visual response informs the user of the key pressed by the user on the remote control.

8. The apparatus as recited in claim 1, wherein the non-visual response is based on a key pressed on the remote control by the user in the context of a sequence of one or more keys on the remote control previously pressed by the user.

9. The apparatus as recited in claim 8, wherein the non-visual response informs the user of an action associated with the depressed key and informs the user of one or more options for additional keystrokes.

10. The apparatus as recited in claim 3, wherein the repeater device further includes an IR receiver, a radio frequency (RF) transmitter and an RF receiver, wherein the RF receiver of the repeater device and the IR transmitter of the repeater device are located remotely relative to the RF transmitter of the repeater device, wherein the repeater mechanism causes the RF transmitter of the repeater device to transmit an RF signal to the RF receiver of the repeater device based on the first IR signal received by the IR receiver of the repeater device from an IR transmitter of the remote control, and wherein the IR transmitter of the repeater device transmits the second IR signal to the IR receiver of the electronic device based on the RF signal.

11. A system for providing non-visual access to an on-screen menu for an electronic device, comprising:
a remote control having a transmitter that transmits a first signal;
an electronic device having an on-screen menu and a receiver that receives a second signal for interaction with the on-screen menu;
an apparatus, comprising:
at least one processor;
a memory coupled to the at least one processor;
a repeater device comprising
a receiver for receiving the first signal from the transmitter of the remote control,
a transmitter for transmitting the second signal to the receiver of the electronic device;
a repeater mechanism residing in the memory and executed by the at least one processor, the repeater mechanism causing the transmitter of the repeater device to transmit the second signal to the receiver of the electronic device, said second signal being based on the first signal received by the receiver of the repeater device from the transmitter of the remote control;
a feedback mechanism residing in the memory and executed by the at least one processor, the feedback mechanism causing a non-visual response to be provided to a user of the electronic device, said non-visual response being based on the first signal received by the receiver of the repeater device from the transmitter of the remote control.

12. The system as recited in claim 11, wherein the first signal and the second signal are infrared (IR) signals.

13. The system as recited in claim 12, wherein an IR transmitter of the repeater device is located at a fixed position in a line of sight relative to an IR receiver of the electronic device.

14. The system as recited in claim 11, wherein the electronic device includes at least one of a DVD player, a digital video recorder (DVR), a video cassette recorder (VCR), a satellite receiver, or a television.

15. The system as recited in claim 11, wherein the non-visual response caused by the feedback mechanism includes providing at least one of an audio message and a Braille message to the user of the electronic device.

16. The system as recited in claim 11, wherein the non-visual response is based on a key pressed on the remote control by the user.

17. The system as recited in claim 16, wherein the non-visual response informs the user of the key pressed by the user on the remote control.

18. The system as recited in claim 11, wherein the non-visual response is based on a key pressed on the remote control by the user in the context of a sequence of one or more keys on the remote control previously pressed by the user.

19. The system as recited in claim 18, wherein the non-visual response informs the user of an action associated with the depressed key and informs the user of one or more options for additional keystrokes.

20. The system as recited in claim 13, wherein the repeater device further includes an IR receiver, a radio frequency (RF) transmitter and an RF receiver, wherein the RF receiver of the repeater device and the IR transmitter of the repeater device are located remotely relative to the RF transmitter of the repeater device, wherein the repeater mechanism causes the RF transmitter of the repeater device to transmit an RF signal to the RF receiver of the repeater device based on the first IR signal received by the IR receiver of the repeater device from an IR transmitter of the remote control, and wherein the IR transmitter of the repeater device transmits the second IR signal to the IR receiver of the electronic device based on the RF signal.

21. A computer-implemented method for providing non-visual access to an on-screen menu for an electronic device having a remote control, the computer-implemented method comprising the steps of:
receiving a first IR signal from an IR transmitter of the remote control;
transmitting a second IR signal to an IR receiver of the electronic device, said second IR signal being based on the first IR signal received from the remote control;
providing a non-visual response to a user of the electronic device, said non-visual response being based on the first IR signal received from the remote control.

22. The computer-implemented method as recited in claim 21, further comprising the steps of:
transmitting an RF signal to an RF receiver, said RF signal being based on the first IR signal received from the remote control;
wherein the step of transmitting the second IR signal to the IR receiver of the electronic device includes the steps of
receiving the RF signal at the RF receiver, and
transmitting the second IR signal to the IR receiver of the electronic device based on the RF signal, which RF signal is based on the first IR signal received from the remote control.

23. A computer program product for providing non-visual access to an on-screen menu for an electronic device having a remote control, comprising:
a plurality of instructions provided on a signal-bearing media, wherein the instructions when executed by at least one processor of a digital computing device, cause the digital computing device to perform the steps of:
transmitting a repeated IR signal to an IR receiver of the electronic device, said IR signal being based on an original IR signal received from an IR transmitter of the remote control;
providing a non-visual response to a user of the electronic device, said non-visual response being based on the original IR signal from the remote control.

24. The computer program product as recited in claim 23, wherein the signal-bearing media comprises recordable media.

25. The computer program product as recited in claim 23, wherein the signal-bearing media comprises communications media.
